(19) United States
(12) Patent Application Publication
(10) Pub. No.: US 2010/0164965 A1
(43) Pub. Date: Jul. 1, 2010

(54) RENDERING MODULE FOR BIDIMENSIONAL GRAPHICS, PREFERABLY BASED ON PRIMITIVES OF ACTIVE EDGE TYPE

(75) Inventors: Massimiliano Barone, Cormano (IT); Mirko Falchetto, Milzano (IT)

Correspondence Address: SEED INTELLECTUAL PROPERTY LAW GROUP PLLC, 701 FIFTH AVENUE, SUITE 5400, SEATTLE, WA, 98104-7092, US

(73) Assignee: STMICROELECTRONICS S.R.L., Agrate Brianza (IT)

(21) Appl. No.: 12/641,062

(22) Filed: Dec. 17, 2009

(30) Foreign Application Priority Data
Dec. 30, 2008 (IT) MI2008A002342

(51) Int. Cl. G06T 1/20

(52) U.S. Cl. 345/506

(57) ABSTRACT

A graphics module for the rendering of a bidimensional scene on a displaying screen is described, comprising a sort-middle-type graphics pipeline, said graphics pipeline comprising: a first rasterizer module so configured as to convert an edge-type input primitive received by a path processing module into a primitive of active-edge-type; a first processing module so configured as to associate said primitive of active-edge-type to respective macro-blocks corresponding to portions of the screen and to store said primitive of active-edge-type into a scene buffer; a second processing module so configured as to read said scene buffer and to provide said primitive of active-edge-type to a second rasterizer module.

### BACKGROUND

1. Technical Field

The present disclosure relates to a rendering module for bidimensional graphics (2D), and particularly, having a graphic processing chain or, in an equivalent manner, a graphics pipeline, for the rendering of bidimensional (2D) scenes.

2. Description of the Related Art

Computerized graphics is the technique of generating images on a hardware device, such as, for example, a screen or a printer, via computer. The generation of objects or images to be represented on a displaying device is usually referred to as rendering.

In the field of the bidimensional (2D) graphics, a 2D graphics pipeline for the rendering of images is known, which is based on a data processing approach in a so-called immediate mode (immediate mode rendering pipeline or, briefly, IMR pipeline).

By immediate mode data processing is meant a processing of the data in the order in which they are received by the 2D graphics pipeline and a contextual rendering of the data processed on the bidimensional display surface. As it can be inferred, in an immediate mode approach, each object to be displayed is processed and rendered on the screen independently from the other objects of the scene.

The IMR-type 2D graphics pipeline has as a drawback to result to be not very efficient in terms of band loading and costs in the case that operations intended both to improve the quality of the scenes to be displayed and intended to reduce the working load of the same graphics pipeline are implemented, therefore the performance of the graphics application in which the pipeline is employed.

### BRIEF SUMMARY

The present disclosure proposes a 2D graphics pipeline of an alternative type compared to the above-mentioned IMR-type 2D graphics pipeline. In some embodiments, the present disclosure may be adapted to at least partially reduce the drawbacks thereof, particularly as regards the band and also memory loading of the graphics pipeline and the performance of the graphics application in which the same graphics pipeline is employed.

In one embodiment of the present disclosure, a graphics module is provided for rendering a bidimensional scene on a displaying screen. In one such embodiment, the graphics module includes a sort-middle graphics pipeline that includes: a first rasterizer module configured to convert an input edge primitive received by a path processing module into an active-edge primitive; a first processing module configured to associate said active-edge primitive to respective macro-blocks corresponding to portions of the displaying screen and to store said active-edge primitive of in a scene buffer; and a second processing module configured to read said scene buffer and to provide said active-edge primitive to a second rasterizer module.

### BRIEF DESCRIPTION OF THE SEVERAL VIEWS OF THE DRAWINGS

Further characteristics and advantages of the present disclosure will become clear from the description reported below of preferred exemplary embodiments, given by way of non-limiting, illustrative examples, with reference to the annexed Figures, in which:

FIG. 1 schematically illustrates a graphics system in accordance with an implementation example;

FIG. 2 schematically illustrates a graphics module according to an example of the disclosure;

FIG. 3 illustrates a graphics pipeline which can be used within the graphics module of FIG. 2 according to an implementation example of the disclosure;

FIG. 4 schematically illustrates an embodiment of a displaying screen on which graphic entities processed by the graphics pipeline of FIG. 3 are represented; and

FIG. 5 schematically illustrates an organization example of an internal memory buffer relative to the graphics pipeline of FIG. 3.

### DETAILED DESCRIPTION

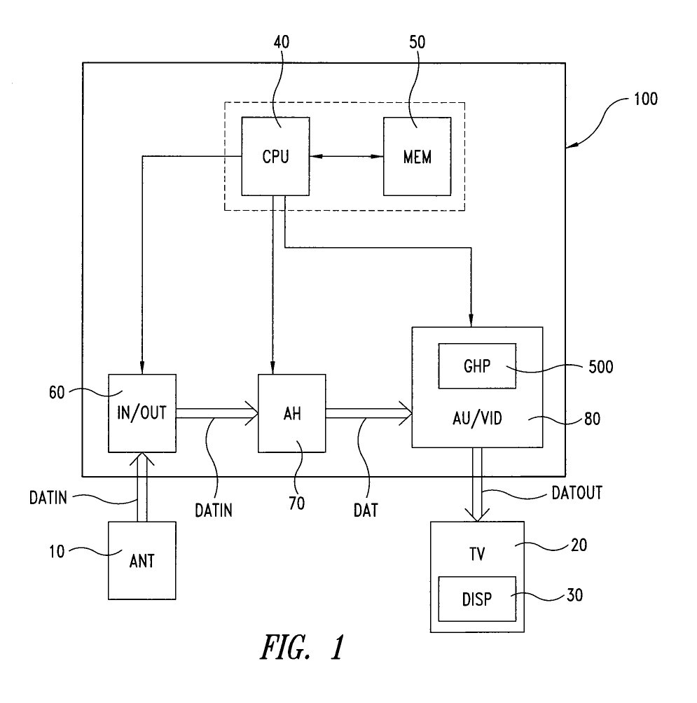

FIG. 1 shows a graphics system 100 in accordance with an implementation example of the disclosure, including a rendering graphics module 500, or also graphics pipeline.

The graphics system 100 of FIG. 1 is, for example, an encoding/decoding apparatus for digital television, also known as set top box but, in accordance with other embodiments of the disclosure, it can be another graphics system, such as mobile telephone, a PDA (Personal Digital Assistant) palmtop, a multimedia device with VGA-type screen (digital terrestrial receiver, DVIX players, or MP3 player), a computer (for example, a personal computer), a gaming device (for example, PS3), and so on.

The encoding/decoding apparatus 100 is preferably of the HDTV type, i.e., for the application in the high definition television (HDTV).

The encoding/decoding apparatus 100 for digital television is configured to receive an encoded input data flow DATIN (video and/or audio data) from an outer antenna 10 (ANT) in order to provide a corresponding encoded data flow DATOUT to a television set 20 (TV) provided with at least one displaying screen 30 (DISP) and operatively connected to the encoding/decoding apparatus 100.

In more detail, the encoding/decoding apparatus 100 comprises a central processing unit 40 (CPU), for example, a microprocessor or a microcontroller, operatively connected to a main system memory 50 (MEM).

The encoding/decoding apparatus 100 further comprises an input/output device 60 (IN/OUT) operatively connected to and controlled by the central processing unit 40 (CPU), in order to receive the encoded input data flow DATIN.

In addition, the encoding/decoding apparatus 100 comprises an electronic device 70 (AH) arranged for the encryption/decryption of digital data. In more detail, the electronic device 70 is a hardware accelerator operating under the control of the central processing unit 40 in order to decrypt the decoded data flow DATIN received by the input/output device 60. Particularly, the hardware accelerator 70 is configured to receive activation signals from the central processing unit 40 to decrypt the data flow DATIN and to send decrypted data DAT to an audio/video decoder 80 (AU/VID) adapted to provide (under the control of the central processing unit 40, to which it is operatively connected) the encoded data flow DATOUT to the television set 20.

The audio/video decoder 80 comprises the rendering graphics module 500 (GHP), or simply graphics module, already mentioned before, which results to be operatively connected to and controlled by the central processing unit 40.

The graphics module 500 is configured to implement a set of functions of the graphics type to render a 2D graphics scene, the description of which is received in input by the encoding/decoding apparatus 100 through the outer antenna 10, then displayed on the displaying screen 30 of the television set 20, optionally by overlapping the 2D graphics scene obtained with the encoded data flow DATOUT, sending the result to the television set 20.

Preferably, the graphics module 500 is a graphics engine configured to render digital images by relieving the central processing unit 40 from additional workloads. For the purposes of the present disclosure, by graphics engine is meant a device which is capable of rendering in hardware or software, not by running on the central processing unit, but by running on another coprocessor such as, for example, a digital signal processor DSP. The terms “graphics accelerator” or “graphics coprocessor”, also usually employed in the computerized graphics field, are completely equivalent to the term graphics engine.

Alternatively, the graphics module 500 can be a graphics processing unit GPU, in which the rendering functions are performed on the basis of software instructions executed by a dedicated processor, such as a DSP, and on the basis of hardware instructions executed by a specially designed hardware logic. In accordance with a further embodiment, some or all of the rendering functions are performed by the central processing unit 40.

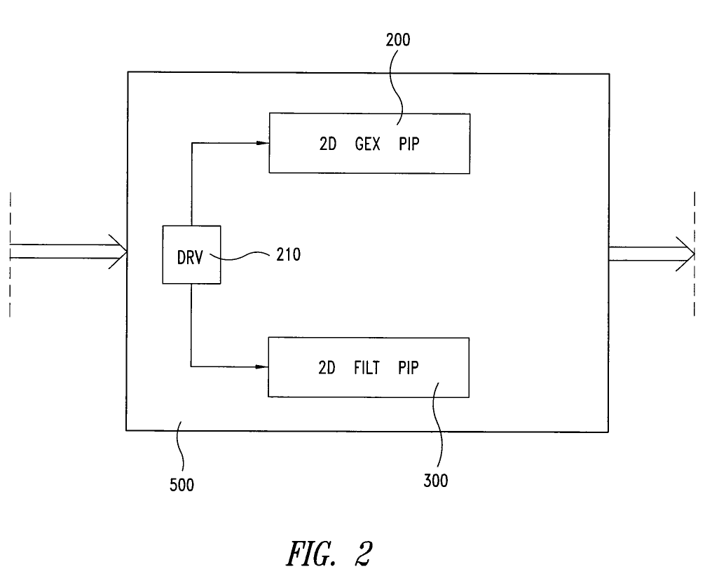

FIG. 2 shows a block diagram of the graphics module 500. Particularly, the graphics module 500 is so configured as to render 2D (bidimensional) scenes on the display 30 of the television set 20.

Particularly, the graphics module 500 in accordance with the example of the disclosure is arranged to render 2D images based on a data processing approach in a so-called delayed mode. Furthermore, the graphics module 500 is preferably so configured as to result to meet the OpenVG open standard, promoted within a panel called Khronos, known in the literature.

By data processing through a delayed mode approach is meant a data processing comprising a first processing of the data received in input by the graphics module and the storing of the processed data in a memory which is internal to the graphics module and, only following a special command received by the graphics application, a second processing intended to display (render) the scene on the screen on the basis of the previously processed and stored data. It shall be noted that in a delayed mode approach, the data are typically processed in a different order compared to that in which they are acquired by the graphics module, which order strictly depends on the graphics application.

It shall be noted that the processing of the data based on a delayed mode approach is known in the 3D (three-dimensional) graphics, and it at the base of the sort-middle rendering SMR hardware architecture, per se known to those skilled in the 3D graphics art, and also known as tile based rendering architecture.

To the light of what has been stated above, the graphics module 500 is to be intended as a graphics pipeline of the sort-middle type for the rendering of bidimensional scenes.

Referring now to FIG. 2, the graphics module 500 comprises a driver module or driver 210 (DRV), a first 2D graphics (GFX) pipeline 200, hereinafter graphics pipeline, and a second 2D filtering pipeline 300, hereinafter filtering pipeline.

The driver module 210 is a driver module in compliance with the 2D OpenVG standard (OpenVG Driver), per se known, having standard interface tasks, and configured to receive commands from programs (for example, Application Programming Interface, API) running on the central processing unit 40 and to translate said commands into specialized commands for the graphics pipeline 200 and/or the filtering pipeline 300.

The pieces of information which can be generated by the driver module 210 comprise: a reference 2D geometric entity (primitive), referred to as a path, hereinafter simply path; a context of a scene to be rendered, hereinafter simply context (particularly, the context organization reflects the one defined by the OpenVG standard); a reference digital (bitmap) image of the VG (Vector Graphics image) type, hereinafter simply VG bitmap image.

As it is known to those of ordinary skill in the art, a “path” is a reference geometric entity of the 2D graphics which is intended as a set of commands of the plotting type to be provided to the 2D graphics pipeline to define the profile of a 2D bidimensional primitive. Particularly, a 2D scene can be defined as a set of VG and/or path bitmap images to which one or more contexts are associated. Such set is sent to the graphics pipeline configured to compose, or better render, the 2D scene on the displaying screen 30. Each path exploits a logic mechanism of the plotting type, which is implemented in plotting a profile of the 2D primitive which the path plots from a starting point to an endpoint.

To this aim, it shall be further noticed that a path complying with the OpenVG standard comprises a first command or segment array (data command or segment) representative of the graphics or movement to be plotted, and a second array of data representative of the X, Y coordinates of the endpoint in which the graphics or movement ends and, for some commands, representative of one or more control points, according to the particular command. It shall be noted that the starting point is to be considered as implicit: at the first command, it has coordinates equal to the conventional origin of the surface on which the graphics is to be plotted, and for the successive commands, it has, from time to time, coordinates that are revised and equal to those of the endpoint of the last executed command. The data of the second array are processed in parallel with the data of the first array according to the command defined therein.

The exemplary set of the main commands which can be indicated in a path comprises: MOVE TO, LINE TO, QUAD BEZIER TO, CUBIC BEZIER TO, ARC TO. To each command are to be associated those data, based on the specific semantics of each particular command, corresponding to the coordinates of the endpoint.

For example, the path “command=MOVE TO; data=X1, Y1” implies a skip from the starting point or origin implicitly reached at the current stage of the computation (for example, with coordinates X0, Y0) to the endpoint with coordinates X1 and Y1. The command “MOVE TO” involves a shift on the surface, but it does not involve any profile plotting on the same surface. The path “command=LINE TO; data=X1; Y1” involves plotting a line from the implicit starting point (for example, with coordinates X0, Y0) to the specified endpoint (X1, Y1); the path “command=ARC TO; data=X1, X1” involves plotting a segment of arc from the starting point to the endpoint (X1, Y1).

For example, the path “command=QUAD BEZIER TO; data=X1, Y1; X2, Y2” involves plotting a degree 2 Bezier curve (exactly, quadratic), passing between the implicit starting point (X0, Y0) and the endpoint (X1, Y1). The datum X2, Y2 represents the control point, and it allows defining, for example, the particular shape of the Bezier curve to be plotted.

Referring back to the pieces of information provided by the driver module 210, by context is meant a set of instructions and/or pieces of information provided by the OpenVG 2D graphics application for the rendering of a scene, typically intended to the 2D graphics pipeline. Some instructions which are typically included in a 2D context are, for example: instructions intended to the processing module path, i.e., path fill, path stroke width; type of affine and/or perspective transformation to be associated to the processing module path; paint type; anti-aliasing type; type of associated VG bitmap image; type of blending equation, and so on.

Finally, the piece of information of the VG bitmap image type, by which is meant a set of adjacent pixels (contraction of picture element), each of which having a given color, also results to be generable by the driver module 210. The bitmap image is such as to be received in input by the 2D graphics pipeline 200 and to be plotted (rendered) directly on the screen following a mapping operation, optionally a perspective one.

Referring back to the graphics module 500 of FIG. 2, it shall be appreciated that the graphics pipeline 200 is so configured as to receive from the driver module 210 pieces of information such as path, context, and VG bitmap images, and a further DRAW PATH or DRAW IMAGE command, which indicates to the same pipeline whether the entity to be processed is a path or a VG bitmap image.

Instead, the filtering pipeline 300 is so configured as to receive from the driver module 210 only context and VG bitmap images. Unlike the graphics pipeline 200, therefore, the filtering pipeline 300 is not arranged to receive in input geometric entities of the path type.

It shall be pointed out that, as it will be stated also herein below, the 2D graphics pipeline 200 is anyway internally configured to process entities of path-type, and not VG bitmap images; therefore, in the case where the entity to be rendered is exactly a VG bitmap image, the driver module 210 is configured to convert the VG bitmap image into an equivalent path P. Particularly, the VG bitmap image is preferably transformed into four commands (particularly, of the LINE TO type), the path of which will represent exactly the outer edge (profile) of the VG bitmap image to be plotted.

This transformation, which can be performed by the driver module 210, advantageously allows a user not having to necessarily provide a path corresponding to the VG bitmap image, but to be able to directly provide bitmap images to the graphics module 500, by preferably arranging only one driver module for both the graphics pipeline 200 (arranged to accept both path and VG bitmap images) and for the filtering pipeline 300 of the graphics module 500 (arranged to accept only VG bitmap images).

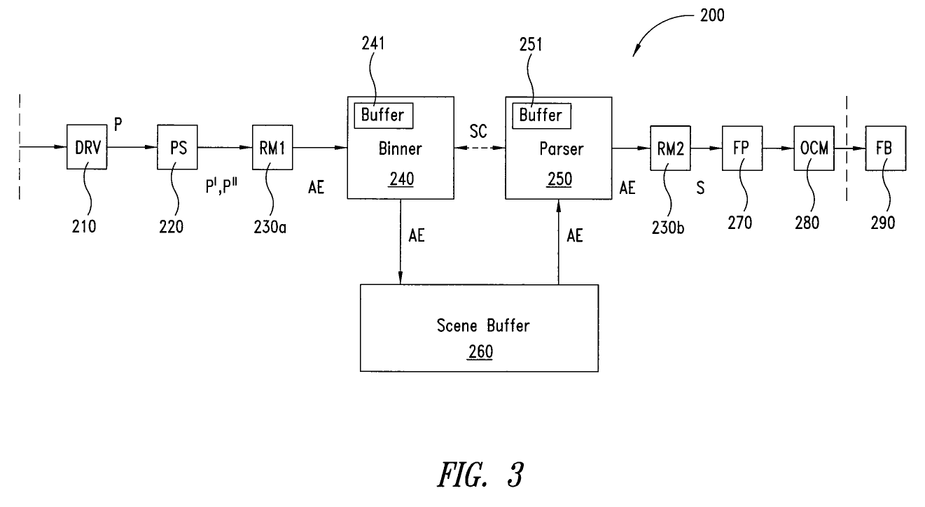

With reference now to FIG. 3, the graphics pipeline 200 is now described in detail.

The graphics pipeline 200 comprises a path processing stage 220 (path stage “PS”), a first rasterizer module 230a (front-end rasterizer “RM1”), a first processing module 240 (binner), a second processing module 250 (parser or analyzer), an inner memory buffer 260 (scene buffer), a second processing module 230b (back-end rasterizer “RM2”), a fragment processor 270 (FP), a macro-block memory module 280 (OnChip memory “OCM”), a frame buffer 290 (FB).

The path processing stage 220, per se known to those of ordinary skill in the 2D graphics art, is so configured as to receive in input an input path P from the driver module 210 (shown for the sake of clarity also in FIG. 3) and to provide a simplified path P′ to the first rasterizer module 230a. The input path P results to be a so-called high-level path, since it comprises all the possible commands (described above) which a path can define. The simplified path P′ results to be a so-called low-level path, and it is exactly simplified compared to the input path P, since it comprises only commands of the MOVE TO or LINE TO type. The simplified output path P′ is usually also referred to as an edge, hereinafter also primitive of edge-type.

As known to those of ordinary skill in the art, by primitive of edge-type is meant a rectilinear segment oriented in a predetermined direction between a start point and an endpoint. The predetermined direction of an edge is established by the comparison between the coordinates Y of the edge start point and endpoint. If the start point coordinate Y is lower than the endpoint coordinate Y, the segment will be orientated in a first direction (for example, upwardly, UP direction); if the start point coordinate Y is equal or higher than the endpoint coordinate Y, the segment will be orientated in a second direction (for example, downwardly, DOWN direction).

With reference again to the path stage 220, it shall be noted that it results to be, in turn, preferably a micro-pipeline comprising a series of processing modules (not shown in FIG. 3) each of which is configured to concur to the generation of the simplified output path or edge P′ starting from the input path P according to the context provided by the driver module 210.

For example, the path stage 220 comprises a per se known tessellator module so configured as to convert the input path P into the simplified output path P″. The output path P′ also comprises a series of commands (typically implicit) of the plotting type (only LINE TO, MOVE TO) with the data being associated to data representative of surface or screen coordinates (screen surface). By surface coordinates are meant coordinates which can be mapped directly into pixels on the screen.

It shall be appreciated that the path stage 220 is so configured as to process the input path P as a function of the instruction included in the context provided by the driver module 210, for example, a path fill instruction or a path stroke width instruction. Both the above-indicated instructions are well known to those of ordinary skill in the art.

Particularly, if the context comprises the path fill instruction, the path stage 220 results to be arranged to provide the simplified output path (or primitive of edge-type) P′ to the first rasterizer module 230a as generated by the tessellator module, since the path fill operation is globally performed by suitably concatenating the operations of both the first rasterizer module 230a and the second rasterizer module 230b. Instead, in the case where the context comprises the path stroke width instruction, the path stage 220 results to be arranged to perform a path P′ stroke width operation on the output path P′ generated by the tessellator module, by means of convolution and widening operations on the basis of a piece of information about the width provided by the context in combination with the path stroke width operation. In this scenery, the path stage 220 results to be arranged to provide a further output path P″ to the first rasterizer module 230a as a result of the output path P′ widening.

Therefore, the path processing stage 220, according to the instructions contained in the context, results to be configured to provide to the first rasterizer module 230a the type of simplified output path (P′ or P″) in a compatible, or anyhow recognizable format, by the first rasterizer module 230a. The selection of the type of simplified output path (P′ or P″) depends, in each case, on the graphics pipeline 200 state.

Furthermore, the path processing stage 220, results to be arranged to perform, for example, a path projection operation on the target screen through a transformation matrix.

The first rasterizer module 230a is a 2D AET FrontEnd (Active Edge Table Rasteriser FrontEnd) rasterizer module, per se known, which results to be operatively associated to the path stage 220, and so configured as to receive therefrom a primitive of edge-type (simplified output path P′, or the further output path P″) and to provide in output a primitive of active edge type AE (edge in surface or screen coordinates).

It is stated that the simplified input path (P′ or P″) at the first rasterizer module 230a results to be a rectilinear segment (edge) orientated on the screen definable by a first point, a second point, and a piece of information representative of the comparison between the coordinates Y of the first and the second point on the screen. Such piece of information indicates the orientation direction of the segment, which can be upwardly or downwardly (up/down piece of information).

By primitive of active-edge-type is meant a primitive of edge-type provided in output by the first rasterizer module 230a as a result of a classification of the primitives of edge-type in input at the first rasterizer module 230a on the basis of the spatial region that each individual input primitive of edge-type takes on the screen.

As it will be described herein below, the above-mentioned classification is implemented according to two principles.

The first principle is based on a criterion of scanning by horizontal lines of the screen (scan lines). According to this criterion, each primitive of edge-type belonging to the simplified input path P′ (or P″) at the first rasterizer module 230a is classified as a primitive of active-edge-type (relative to a i-th horizontal scan line), if said primitive of edge-type intersects the same scan line in one point.

By way of example, given a displaying screen (W×H) where W represents the number of columns, and H represents the number of rows, the number of scan lines results to be equal to H. Particularly, each i-th scan line results to be passing through each center of the adjacent pixels on such line.

The second classification principle is based on a second assessment criterion which, in accordance with the example of the disclosure, is based on a macro-block association which is described in detail herein below.

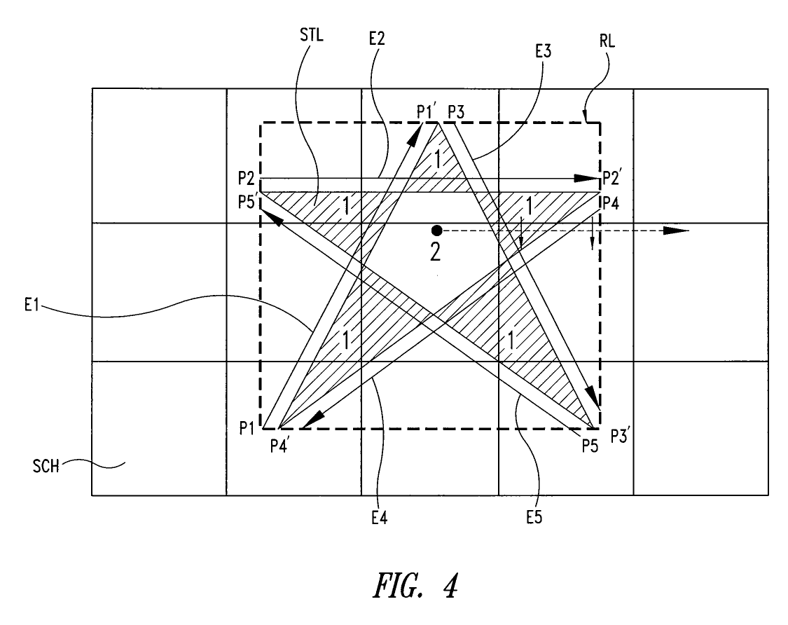

Referring now to FIG. 4, an example of set of primitives of active-edge AE (individuated according to a macro-block association) orientated on a screen SCH (for example, the display 30 of the television set 20) is now described. The set of primitives of active-edge-type AE concurs to the definition of the profile of the input path P coming from the driver module 210.

In the example of FIG. 4, the input path P is a star figure STL, and the set of primitives of active-edge with which the star figure STL is approximated comprises a first active edge E1, a second active edge E2, a third active edge E3, a fourth active edge E4, and a fifth active edge E5.

The first active edge E1 is defined by a start point P1, an endpoint P1′, and an UP direction (UP); the second active edge E2 is defined by a start point P2, an endpoint P2′, and a horizontal direction (DOWN due to the previously described convention); the third active edge E3 is defined by a start point P3, an endpoint P3′, and a DOWN direction (DOWN); the fourth active edge E4 is defined by a start point P4, an endpoint P4′, and a DOWN direction (DOWN); the fifth active edge E5 is defined by a start point P5, an endpoint P5′, and an UP direction (UP).

It is pointed out that the above-indicated direction of each active edge is obtained, as already stated before, by the comparison between the start point and the endpoint coordinates Y.

Referring again to FIG. 3, the first processing module (binner) 240 is so configured as to receive in input the primitive of active-edge-type AE received from the first rasterizer module 230a and to associate it to a macro-block representative of the displaying screen SCH and belonging to the set of macro-blocks in which the primitive of path-type to be rendered on the screen is contained.

It is pointed out that, in the example of FIG. 4, the displaying screen SCH portion shown comprises a set of 15 macro-blocks, while the star figure STL to be rendered takes a sub-set of 9 macro-blocks.

Particularly, the first processing module 240 results to be arranged to know from the context provided by the 2D graphics application a piece of information representative of the size of each macro-block in which the displaying screen on which the scene is to be rendered results to be able to be divided.

By definition, a macro-block is a portion of the screen having size N×M, where N and M (preferably, powers of two) represent, each, a number of pixels predetermined by the context of the 2D graphics application. The size of the macro-block N×M is to be intended as fixed, since it is a static characteristic of the end hardware architecture (graphics system) to which the graphics module 500 is directed.

Contextually to the primitives of active-edge-type AE and the size of a macro-block, the first processing module 240 is also configured to receive a piece of information relative to the only sub-context of the fragment processor 270 and the second rasterizer module 230b arranged downstream the second processing module (parser) 250.

The first processing module 240 results to be so configured as to store the pieces of information relative to the primitives of active-edge-type and the relative sub-context in the memory buffer 260, on the basis of the acquired size of the individual macro-block according to an organization of the memory area corresponding to the memory buffer 260 defined by a specific data structure, which will be dealt with herein below.

Particularly, the first processing module 240, once the piece of information indicative of the size N×M of the individual macro-block has been acquired, is so configured as to generate a display list-type data structure associated to each scene macro-block to be rendered, such as to organize the storing of data within the scene buffer 260 in a compact manner, and therefore in a particularly advantageous manner.

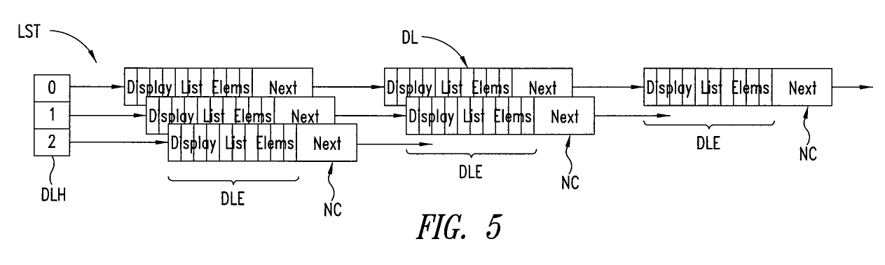

An example of list-type data structure, indicated by the reference LST, is shown in FIG. 5. The list-type data structure LST is preferably a dynamic array of the scene buffer 260 comprising an array of display list headers DLH and a plurality of array of display lists DL. Each array of display list of the plurality DL is organized in fixes-size memory portions or chunks which are mutually concatenated.

Each element of the array of display list headers DLH represents an address of a memory portion of the scene buffer 260 in which the first portion of the display list DL is included.

The array of display list header DLH is typically allocated in an initial portion of the memory area corresponding to the scene buffer 260. The number of elements D of the header array, representative of the length of the array of display list header DLH, is calculated by the first processing module 240 by implementing the following relationship:

D=ceiling(W/N)×ceiling(H/M) (1.0)

As defined by the relationship (1.0), the value D is as a function of the dimensions of the individual macro-block (N×M) and the resolution of the displaying screen (W×H). It shall be noted that the screen resolution (W×H) is to be intended as the current resolution of the screen at the moment when the first processing module 240 implements the relationship (1.0). In fact, the screen resolution could vary in accordance with the rendering surface associated to the graphics pipeline 200 in particular moments of the computation. As regards the computation as such, it is pointed out that the command ceiling represents a rounding up to the nearest higher integer compared to the division operation indicated in brackets.

By way of example, by supposing that the macro-block has a fixed size equal to (64×32) and the graphics pipeline 200 is configured to render a scene on a screen having a current size equal to (800×600), the number of elements of the array of display list header (therefore, also the display list number) is equal to D=ceiling(800/64)×ceiling(600/32)=13×19=247.

As regards an individual display list, each portion of a display list comprises a fixed number of list elements DLE (in the example of FIG. 5, equal to 10) and a handle NC to the memory address of the scene buffer 260 in which the display list portion of the same display list is allocated. The first processing module 240 is so configured as to associate the newly generated display list portion to the handle NC of a display list portion preceding the memory address of the scene buffer 260 in which the newly generated display list portion is allocated. This type of organization is dynamic, since, advantageously, in the case where a display list DL is complete, the first processing module 240 is so configured as to generate a new display list portion to be successively concatenated to the last generated display list portion.

This organization of the scene buffer into concatenated display list portions allows the first processing module 240 efficiently storing display lists, since it is possible to load the display lists from an external memory (not shown in the Figures) into a local buffer (scene buffer) having a size which is equal to the fixed size, known a priori, of each memory portion (chunk).

A display list element DLE is, for example, a 32-bit data structure in which the most significant 4 bits are representative of an operative code (to a maximum of 16 different operative codes definable), while the remaining 28 bits are representative of semantics in accordance with the operative code which they are associated to.

It shall be noted that the type of operative code discriminates the type of display list element. For example, in the case where the operative code is a handle to a memory address in which a given context which had been previously stored is allocated, the remaining 28 bits are used to store the above-mentioned memory address. Another example of an operative code can be relative to the encoding of a per se known macro-block masking operation. In this case, the remaining 28 bits indicate the type of masking operation. Other examples of operative code can be memory buffer or macro-block clearing operations. In this case, the 28 bits indicate the corresponding memory area to be cleared.

The first processing module 240 is further configured, following the generation of the list-type data display structure, to store a sub-context associated to the instruction “DRAW”, which it can receive from the graphics application through the driver module 210.

It shall be noted that the very sub-context to be stored in the scene buffer is the one which can be associated only to the second processing module 230b (for example, fill rule) and to the fragment processor 270.

Furthermore, it shall be considered that, since a same sub-context can be shared by different primitives of active-edge-type, it is stored in the scene buffer 260 only once, and it is associated to each primitive of active-edge-type AE by using a respective element of display list of the display list structure comprising a pointing operative code and an address of the memory area of the scene buffer in which the shared sub-context is allocated.

It shall be further noticed that the sub-context associated to the fragment processor 270 is provided by the OpenVG specifics; therefore the maximum size thereof is a piece of information known a priori to the 2D graphics pipeline.

Referring back to the first processing module 240, it comprises a first local write memory buffer 241 to locally store the sub-context.

The first processing module 240 is advantageously configured to locally store (in a compact representation thereof) the sub-context in the first local write memory buffer 241 and, subsequently, once the sub-context has been locally acquired, to transfer and store the sub-context in the scene buffer 260 through an individual access to an external memory. The use of the local write memory buffer 241 is advantageous, since the context size is not known a priori, but has a maximum size that is defined by OpenVG standard specifics.

It shall be noted that the size of the compacted sub-context may vary as a function of the values of the same context. In fact, as it is known, in the OpenVG standard, a path or a VG bitmap image can be rendered with the addition of several options such as, for example, the definition of a specific image for a particular primitive.

Contextually, the first processing module 240 is arranged to store a memory address in an internal register of its own (not shown in the Figures), which is representative of the scene buffer memory area in which the sub-context is stored. The first processing module 240 is configured to associate this address to each primitive of active-edge-type (active edge) AE which it will receive from the first rasterizer module 230a and which will subsequently be sent to the second rasterizer module 230b.

In addition, it shall be noted that the first processing module 240 is intended to first acquire the sub-context, and next the primitives of active-edge-type AE. This advantageously allows to the first processing module 240 to associate the reference sub-context to each input primitive of active-edge-type, and to store this piece of information in each of the display lists of each macro-block intersecting the input primitive of active-edge-type.

It is stated that the first processing module 240 is so configured as to receive from the first rasterizer module 230a the input primitives of active-edge-type which it generated in accordance with the primitive of path-type P to be rendered. Particularly, such input primitives of active-edge-type are representative of the profile of the primitive of path-type to be rendered (in FIG. 4, star figure STL) in accordance to the region of the screen in which the primitive of path-type is mapped.

In the example of FIG. 4, the primitive of path-type (star STL) results to be mapped within a path bounding box RL represented with a dashed line. For the purposes of the present description, by path bounding box is meant the minimum region of the screen which completely includes the primitive of path-type to be rendered.

It shall be noted that the first processing module 240 is so configured as to insert, for each macro-block of the displaying screen intersecting the bounding box RL, a handle to a memory area in which the context in the display list of each macro-block is stored.

Contextually, the first processing module 240 is so configured as to insert a handle in the display list of each macro-block, to another memory area in which a set of pieces of information of primitives of active-edge (“edge data set handle”) is stored. It is pointed out that by set of pieces of information of primitives of active-edge (“edge data set”) is meant the set of edge primitives defining the profile of the primitive of path-type P to be rendered on the screen SCH, classified according to the classification based on the previously described scanning criterion by horizontal lines of the screen (scan lines).

Referring again to FIG. 3, the second processing module 250 results to be operatively associated to the scene buffer 260 to load from the memory buffer 260 the input primitive of active-edge-type AE and to provide said primitive of active-edge-type AE to the second rasterizer module 230b (AET Rasterizer back-end).

It shell be further noted that, as symbolically illustrated also in FIG. 3, the first 240 and second 250 processing modules share also per se known synchronism signals SC.

Particularly, the first processing module 240 is configured to capture the data relative to the context (or sub-context) of the scene to be rendered and the data relative to the primitives of active-edge-type as received from the first rasterizer module 230a and to store them in a compact representation (primitives of active-edge-type associated to respective macro-blocks of the screen).

The second processing module 250 is so configured as to perform the opposite or dual role relative to that of the first processing module 240. Particularly, the second processing module 250 is arranged to read the data stored in the scene buffer 260 and, proceeding according to a given order for the macro-blocks, to re-set the local sub-context of the second rasterizer module 230b and of the fragment processor 270 and to identify the set of pieces of information of primitives of active-edge (“edge data set”) stored therein.

It shall be noted that the data processing by the second processing module 250 begins when the graphics application, through the driver module 210, provides the command to show the rendered scene on the screen to the graphics pipeline 200, also referred to as a command SHOW. Contextually to the command SHOW, further commands can be provided, as provided for by the OpenVG standard, which indicate to proceed with the flush (or finish) of the graphics pipeline 200 (processing of the data stored within the scene buffer).

It shall be noted that, as it is known, a sort-middle graphics pipeline is configured for a real processing of the data of the previously captured scene only upon reception of one of the above-mentioned commands from the graphics application

It shall be further considered that, since each macro-block into which the displaying screen can be clipped is independent from the other macro-blocks, the modules of the graphics pipeline 200 downstream the first processing module (for example, the second processing module 250, the second rasterizer module 230b, the fragment processor 270, the macro-block memory module 280) are advantageously configured to operate in parallel.

Referring back to the second processing module 250, it comprises a second local write buffer 251 to store the i-th display list corresponding to the i-th macro-block read and withdrawn from the scene memory buffer 260 by the second processing module 250.

It shall be noted that, advantageously, in an alternative embodiment, it is possible to store a display list portion associated to the macro-block in the second local write buffer 251, thereby enhancing the performance of the graphics pipeline 200.

The second processing module 250 is further so configured to load a current context of a macro-block region being processed by further external memory buffers relative to the second processing module (for example, an alpha-mask buffer and a frame buffer) in the macro-block memory module 280.

It shall be noted that in the above-mentioned further external buffers, data useful for the representation of the macro-blocks could be stored, such as, for example, background images previously processed by the filtering pipeline 300 (FIG. 2). In fact, typically, the graphics module 500 is advantageously arranged to load the data processed by the filtering pipeline 300 before the graphics pipeline 200 proceeds to render the scene.

Subsequently to the loading of the current context, the second processing module 250 is so configured as to read one or more display list elements stored in the memory buffer 260. Particularly, the second processing module 250 is so configured as to acquire from the memory buffer 260 all the pieces of information relative to the primitives of active-edge-type belonging to the primitive of path-type P to be rendered. Furthermore, the second processing module 250 also results to be configured to check whether the primitive of active-edge-type intersects (even only partially) the individual macro-block region and, in the positive case, to send the same primitive of active-edge-type to the second rasterizer block 230b for further processing operations.

Once all the primitives of active-edge-type of a primitive of path-type (intersecting the current macro-block region) are correctly read by the memory buffer by the second processing module 250, it results to be so configured as to send the primitives of active-edge-type to the second rasterizer block 230b (in accordance with associated fill rules).

The second rasterizer module 230b results to be, in turn, arranged to convert the primitives of active-edge-type AE into primitives of span-type to be provided to the fragment processor 270.

As it is known to those of ordinary skill in the 2D graphics art, by “span” is meant a set of horizontally adjacent fragments of the screen having the same coverage compared to the primitive of path-type defined by the primitives of active-edge-type AE coming from the second rasterizer module 230b. By fragment is meant a set of pieces of information of pixel comprising a set of attributes for each pixel, such as, for example, color and coordinate values. By coverage is meant the percentage of fragment overlap compared to the primitive of path-type defined by the primitives of active-edge-type. The coverage value, or coverage, is defined as a number ranging between 0 and 1.

A fragment completely included within the primitive of path-type has a total overlap relative to it, therefore a coverage percentage of 100% (by definition, coverage value=1). Instead, a fragment which is at the level of the profile of the primitive of path-type has, compared to it, a partial overlap, therefore a coverage percentage below 100% (by definition, coverage value <1).

The spans which can be generated by the rasterizer module 230b can be of two types: internal span, i.e., a set of mutually adjacent fragments internally overlapped to the primitive of path-type (coverage value equal to 1); border span, i.e., a set of adjacent fragments partially overlapped to the primitive of path-type (same coverage value, in this case, below 1).

The second rasterizer module 230b is so configured as to decide, based on the set of fill rules, which fragments are within or outside a particular profile of the path to be rendered. For each fragment which is produced, a particular coverage value is established.

Once the processing of the display list for the current macro-block being processed is completed, the content of the macro-blocks has to be transferred in an external frame buffer (and optionally in an alpha mask buffer, if it is enabled).

In the case where a super-sampling-based anti-aliasing algorithm is used, the macro-block inner memory is considered as under super-sampling resolution. Therefore, a low sampling filter (obtained by calculating the average of the sub-pixels colors) is adopted in the case where the data are stored in an external frame buffer.

In addition, once the processing of a current macro-block has been completed, the second processing module 250 is so configured as to provide the data relative to the macro-block processing, via the fragment processor 270 and the macro-block memory module 280, to one or more frame buffer 290 external to the graphics pipeline 200 (for example, display buffer 30, alpha mask buffer, and so on).

As it shall be noted, the graphics pipeline 200 has several advantageous aspects.

In fact, the order of the modules or blocks constituting the graphics pipeline 200 has the advantage that the scene context to be stored in the scene buffer is actually a sub-context intended to the second rasterizer module 230b and to the fragment processor 270, therefore it is more compact compared to the complete scene context intended to the whole graphics pipeline. In this manner, it is possible to obtain a reduction of the reading/writing band of the scene buffer.

Furthermore, the processing of a macro-block one at a time advantageously allows maintaining the bandwidth confined within the graphics pipeline 200 and in an inner memory module 280 that represents the macro-block.

In addition, the fact that the primitives exiting from the rasterizer module 230 are associated to the macro-blocks advantageously does not involve any particular reconfiguration or modification (hardware or software) operation of the same rasterizer module.

Again, the technical characteristic relative to the compact representation of the data (context and primitives of active-edge-type) according to a display list organization, each associated to a macro-block of the screen, advantageously allows saving the internal write (traffic from first processing module (binner) to scene buffer) and reading (traffic from scene buffer to second processing module (parser)) band.

The various embodiments described above can be combined to provide further embodiments. Each of the characteristics described as belonging to a possible embodiment can be implemented independently from the other embodiments described. These and other changes can be made to the embodiments in light of the above-detailed description.

In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A graphics module for rendering a bidimensional scene on a displaying screen, comprising:
a sort-middle graphics pipeline, including:
a first rasterizer module configured to convert an input edge primitive received by a path processing module into an active-edge primitive;
a first processing module configured to associate said active-edge primitive to respective macro-blocks corresponding to portions of the displaying screen and to store said active-edge primitive of in a scene buffer; and
a second processing module configured to read said scene buffer and to provide said active-edge primitive to a second rasterizer module.

2. The graphics module according to claim 1 wherein the first processing module is further configured to organize active-edge primitives stored in the scene buffer according to a list data structure.

3. The graphics module according to claim 2 wherein the list data structure comprises a plurality of display lists and an array of display list headers.

4. The graphics module according to claim 3 wherein each display list of the plurality of display lists comprises mutually concatenated display list portions representative of memory portions of the scene buffer.

5. The graphics module according to claim 4 wherein each element of the array of display list headers is representative of an address of a scene buffer portion in which a first portion of each display list is allocated.

6. The graphics module according to claim 5 wherein each portion of the display list comprises a plurality of display list elements, and a handle to the successive display list portion.

7. The graphics module according to claim 1 wherein the first processing module is further configured to receive information representative of a sub-context of the bidimensional scene to be rendered, and to store said piece of information in the scene buffer.

8. The graphics module according to claim 7 wherein the first processing module comprises a first local write memory buffer in which the sub-context is to be locally stored before transferring it to the scene buffer.

9. The graphics module according to claim 8 wherein the first processing module further comprises an inner register configured to store a memory address representative of where in the scene buffer the sub-context is stored.

10. The graphics module according to claim 9 wherein the first processing module is further configured to store the piece of information in the display list of the respective macro-block.

11. The graphics module according to claim 1 wherein the second processing module comprises a second local memory buffer to store a display list associated with a macro-block being processed.

12. The graphics module according to claim 11 wherein said graphics pipeline further comprises a macro-block memory module to store pieces of information relative to the macro-block being processed.

13. The graphics module according to claim 1 wherein the second rasterizer module is further configured to generate, on the basis of the active-edge primitive provided by the second processing module, a span primitive, said graphics pipeline further including a fragment processor configured to receive said span primitive.

14. The graphics module according to claim 1 wherein the graphics pipeline further includes a driver module configured to provide a path primitive to the path processing module, said path processing module being configured to convert the path primitive into a simplified path primitive.

15. A graphics system, comprising:
a processing unit;
a memory module operatively associated to said memory module;
a graphics module operatively associated to said processing unit, the graphics module configured to render a bidimensional scene on a displaying screen, the graphics module including a sort-middle graphics pipeline that includes:
a scene buffer;
a first rasterizer module configured to convert an input edge primitive received by a path processing module into an active-edge primitive;
a first processing module configured to associate said active-edge primitive to respective macro-blocks corresponding to portions of the displaying screen and to store said active-edge primitive in said scene buffer; and
a second processing module configured to read said scene buffer and to provide said active-edge primitive to a second rasterizer module.

16. The graphics system according to claim 15, being one of an HDTV set top box, a mobile telephone, a PDA device, digital terrestrial receiver, a DVIX player, an MP3 player, a personal computer, a game console.

17. The graphics system according to claim 15 wherein the first processing module is further configured to organize the active-edge primitive stored in the scene buffer according to a list data structure.

18. The graphics system according to claim 15 wherein the first processing module is further configured to receive information representative of a sub-context of the bidimensional scene to be rendered, and to store said piece of information in the scene buffer.

19. The graphics system according to claim 15 wherein the second processing module comprises a second local memory buffer to store a display list associated with a macro-block being processed.

20. The graphics system according to claim 15 wherein the second rasterizer module is further configured to generate, on the basis of the active-edge primitive provided by the second processing module, a span primitive, said graphics pipeline further including a fragment processor configured to receive said span primitive.

21. The graphics system according to claim 15 wherein the graphics pipeline further includes a driver module configured to provide a path primitive to the path processing module, said path processing module being configured to convert the path primitive into a simplified path primitive.

22. A method, comprising:
rendering a bidimensional scene on a displaying screen, the rendering including:
converting, by a first rasterizer module, an input edge primitive received by a path processing module into a active-edge primitive;
associating, by a first processing module, said active-edge primitive to respective macro-blocks corresponding to portions of the displaying screen;
storing, by said first processing module, said active-edge primitive in a scene memory buffer; and
reading, by a second processing module, said scene memory buffer to provide said active-edge primitive to a second rasterizer module.

23. The method according to claim 22 further comprising organizing, by the first processing module, the active-edge primitive in the scene memory buffer according to a list data structure.

24. The method according to claim 22 further comprising:
receiving, by the first processing module, information representative of a sub-context of the bidimensional scene to be rendered; and
storing, by said first processing module, said piece of information in the scene memory buffer.

25. The method according to claim 22 further comprising storing, by the second processing module, in a local memory buffer a display list associated with a macro-block being processed.

26. The method according to claim 22 further comprising generating, by the second rasterizer module, a span primitive based on the provided active-edge primitive.
